(19) United States
(12) Patent Application Publication
(10) Pub. No.: US 2002/0145315 A1
(43) Pub. Date: Oct. 10, 2002

(54) Energy management device for vehicle

(76) Inventors: Gregory S. Fraley, Farmington Hills, MI (US); Thomas J. Fowler, Clarkston, MI (US); Mladen Humer, East Pointe, MI (US); Stephen Lambrecht, New Hudson, MI (US); H. Winston Maue, Northville, MI (US); Ernesto E. Blanco, Belmont, MA (US); Jennifer Navarro, Saratoga Springs, NY (US); Colin Ager, Cambridge (GB); Alastair MacGregor, Cambridge (GB); Peter Cauwood, Cambridge (GB)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/007,166

(22) Filed: Oct. 24, 2001

Related U.S. Application Data
(60) Provisional application No. 60/243,231, filed on Oct. 25, 2000.

(51) Int. Cl. B60N 2/42; B60R 21/01; B60R 21/02

(52) U.S. Cl. 297/216.13; 297/216.14; 297/216.15; 297/216.16

(57) ABSTRACT

An apparatus for a vehicle, such as a vehicle seat, includes a vehicle component having a first portion fixed relative to the vehicle, and a second portion movable relative to the first portion. An energy management device is connected to the first and second portions. The device controls the motion of the second portion relative to the first portion through a duration of time during rapid acceleration of the vehicle component to reduce peak acceleration forces acting on the vehicle component.

### CROSS REFERENCE TO RELATED APPLICATIONS

This application claims the benefit of U.S. Provisional Application No. 60/243,231 filed Oct. 25, 2000.

### BACKGROUND OF THE INVENTION

This invention relates in general to energy management devices adapted for vehicle components, such as vehicle seats, for dissipating or managing energy relative to time to help minimize front and rear collision forces experienced by the seat occupants generally during forward or rearward impacts.

In a vehicle impact condition, sudden large impact forces may be delivered to the occupant of the vehicle, such as in a rearward or frontal impact. In a rearward impact, the occupant is initially forced against the vehicle seat, and may experience a large energy pulse. In a forward impact, in vehicle seats which incorporate the belt restraint system directly onto the seat back, the occupant will engage the restraint system, and therefore may receive a large energy pulse from the restraint system supported by the seat.

To absorb the energy during a large energy pulse, several devices have been developed. For example, commonly-assigned U.S. Pat. No. 5,722,722 to Massara discloses a vehicle seat energy absorber including a recliner/damper assembly which dampens energy of the seat back as it pivots with respect to the seat track in a high energy impact. The damper mechanism comprises a bi-directional damper that provides a different damping behavior in the forward and rearward directions. The recliner mechanism includes a clevis pin that is explosively released in a high energy impact to selectively disengage the recliner mechanism from the damper mechanism to allow the damper mechanism to dissipate energy of the seat back as it pivots with respect to the seat track. The damping ratio of the damper mechanism can be changed based upon the sensed weight of the vehicle occupant or based upon the seat back angle. However, the damping ratio of the damper mechanism is not controlled in a time dependent manner prior to or throughout the crash event.

In another example, commonly-assigned U.S. Pat. No. 5,826,937 to Massara discloses an energy absorbing seat assembly that includes a head restraint system incorporating a damper mechanism positioned between the upper end of the seat back and the heat restraint for energy management in a high energy impact. The damper mechanism is configured to dissipate head restraint energy in a rearward impact to cushion the load transfer between the occupant and the head restraint. The damping ratio of the damper mechanism may also be changed based upon the sensed weight of the vehicle occupant, however, the damping ratio is not controlled in a time dependent manner prior to or throughout the crash event.

### BRIEF SUMMARY OF THE INVENTION

This invention relates in general to energy management devices adapted for vehicle components, such as vehicle seats, for dissipating or managing energy relative to time to help minimize front and rear collision forces experienced by the seat occupants generally during forward or rearward impacts. The apparatus of the present invention can be a vehicle seat, for example, having a first portion fixed relative to the vehicle, and a second portion movable relative to the first portion. An energy management device is connected to the first and second portions. The device controls the motion of the second portion relative to the first portion through a duration of time during rapid acceleration of the vehicle component to reduce peak acceleration forces acting on the vehicle component.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a graphical representation of the acceleration experienced by an occupant in a vehicle impact in relation to time.

FIG. 2 is a graphical representation of the force experienced by an occupant in a vehicle impact in relation to time present invention.

FIG. 3 is a schematic side elevation view of a vehicle seat equipped with energy management devices, in accordance with the present invention.

FIG. 4 is a schematic view of a first embodiment of an energy management device.

FIG. 5 is a schematic view partially in cross-section of a second embodiment of an energy management device.

FIG. 6 is a schematic cross-sectional view of a third embodiment of an energy management device.

FIG. 7 is an enlarged cross-sectional view of a portion of the device of FIG. 6.

FIG. 8 is a cross-sectional view of the portion of the device of FIG. 6 taken along Lines 8-8 of FIG. 7.

FIG. 9 is a schematic cross-sectional view of a fourth embodiment of an energy management device.

FIG. 10 is a schematic cross-sectional view of a fifth embodiment of an energy management device.

FIG. 11 is a schematic cross-sectional view of a sixth embodiment of an energy management device.

FIG. 12 is a schematic cross-sectional view of a seventh embodiment of an energy management device.

FIG. 13 is a schematic cross-sectional view of a eighth embodiment of an energy management device.

FIG. 14 is a schematic cross-sectional view of a ninth embodiment of an energy management device.

FIG. 15 is a schematic cross-sectional view of a tenth embodiment of an energy management device.

FIG. 16 is a schematic exploded perspective view of an eleventh embodiment of an energy management device.

FIG. 17 is a schematic cross-sectional view of the device of FIG. 16.

### DETAILED DESCRIPTION OF THE INVENTION

This invention relates to energy management devices (or “energy managers”) connected to a vehicle component for dissipating or managing energy relative to time to help minimize collision or rapid acceleration or deceleration forces experienced by the occupants of the vehicle, as well as components of the vehicle, such as during forward or rearward impacts. The term “acceleration” as used and described herein may refer to both acceleration and deceleration, wherein the rate of change of velocity with respect to time can be a positive or negative value, e.g., increasing or decreasing with respect to an external reference frame.

The energy management devices in cooperation with a vehicle component manage the motion of the occupant through a duration of time, thereby reducing peak forces on the occupant to help reduce head and neck injury, for example. Examples of suitable vehicle components for use with the energy management devices include vehicle seats, knee bolster assemblies, and exterior bumpers. For example, the motion of the seat and integrated restraints or belts can be controlled through time. Preferably, the energy management devices are actively controlled during the event so that the energy dissipating rates of the vehicle component can be altered depending on various factors, such as for example, the severity of the impact forces, weight of the vehicle, vehicle speed, and the weight and position of the vehicle occupant. Although the invention will be described and shown herein being associated mainly with vehicle seats, it should be understood that the invention may be practiced with any suitable vehicle component in which it is desirable to reduce its dissipation rate during acceleration, preferably for reducing injury to vehicle occupants and damage to vehicle components. Examples of other vehicle components which can be operatively connected to one or more of the energy management devices described and shown herein are knee bolster panels located adjacent an occupant's knees for effecting the acceleration rate of the panel and occupant, and exterior bumpers of a vehicle for reducing the peak acceleration forces imparted on the bumper caused by an impact.

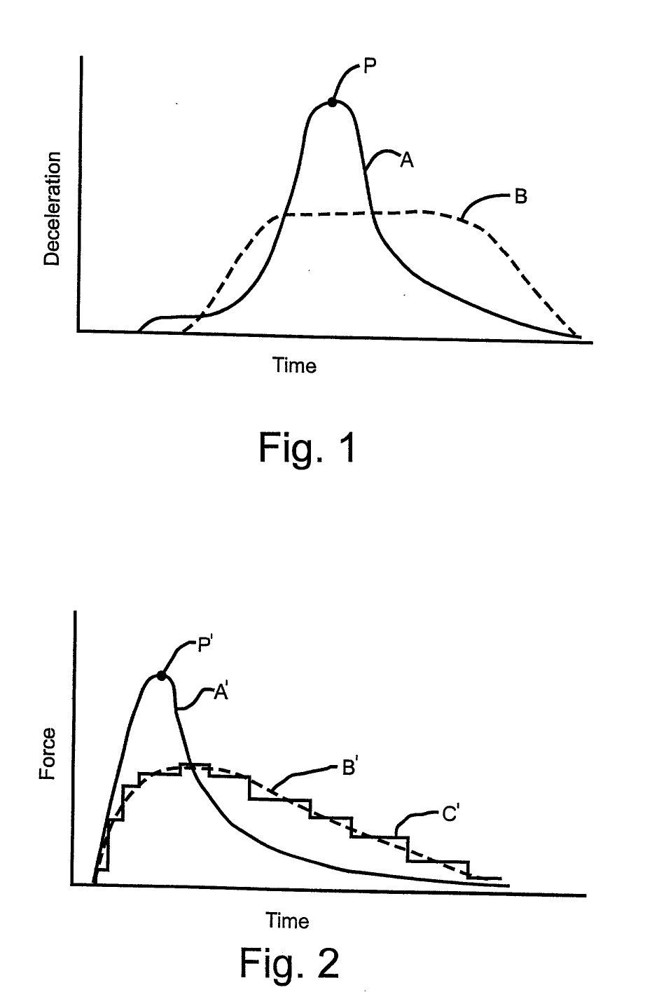

The devices manage occupant motion through time, and preferably dissipate energy over time reducing the peak forces experienced by the occupant, for example, reducing head, neck, and chest injury. There is illustrated in FIG. 1 an example of a graphical representation of deceleration (or acceleration) experienced by an occupant in a vehicle impact in relation to time. A solid line “A” represents a typical acceleration experienced by an occupant of the vehicle without an energy management device. A dashed line “B” represents a desired acceleration experienced by the occupant wherein a vehicle component which is adapted to contact the occupant, such as a seat, is configured with an energy absorbing device. There is illustrated in FIG. 2, an example of a graphical representation of a force acting on the occupant from the relatively rapid acceleration in relation to time. A solid line “A′” represents the force acting on the occupant without an energy management device. A dashed line “B′” represents a desired force experienced by the occupant wherein a vehicle component which is adapted to contact the occupant is configured with an energy absorbing device. As shown in FIGS. 1 and 2, the occupant experiences a relative high acceleration and force at a peak “P” and “P′” in a relatively short duration. However, with a vehicle component equipped with an energy management device, the peak is reduced and spread throughout a longer duration of time.

As will be explained below, if the vehicle component is a seat, the devices can be actuated through rotation of the seat back (e.g., the rotational movement of the seat back relative to the seat bottom) or through linear translation of the seat (e.g., the linear fore and aft movement of the seat bottom relative to the vehicle floor). This movement results from the force created by the relative acceleration of the mass of the seat and occupant system during collision. It is generally desirable to translate the seat or seat back a predetermined angle or length (translation) regardless of the severity of the impact forces. However, for relatively large impact forces, the energy absorbing devices should accept a large load within their translation. Contrary, for relatively small impact forces, the energy absorbing devices should accept a small load within their translation.

Referring to FIG. 2, although it may be desired to obtain a relatively smooth curve represented by broken lines B′, the energy management devices may be easier to manufacture and operate to obtain a more linear stepped plot, represented as solid lines “C”, which generally simulates the plot of B′.

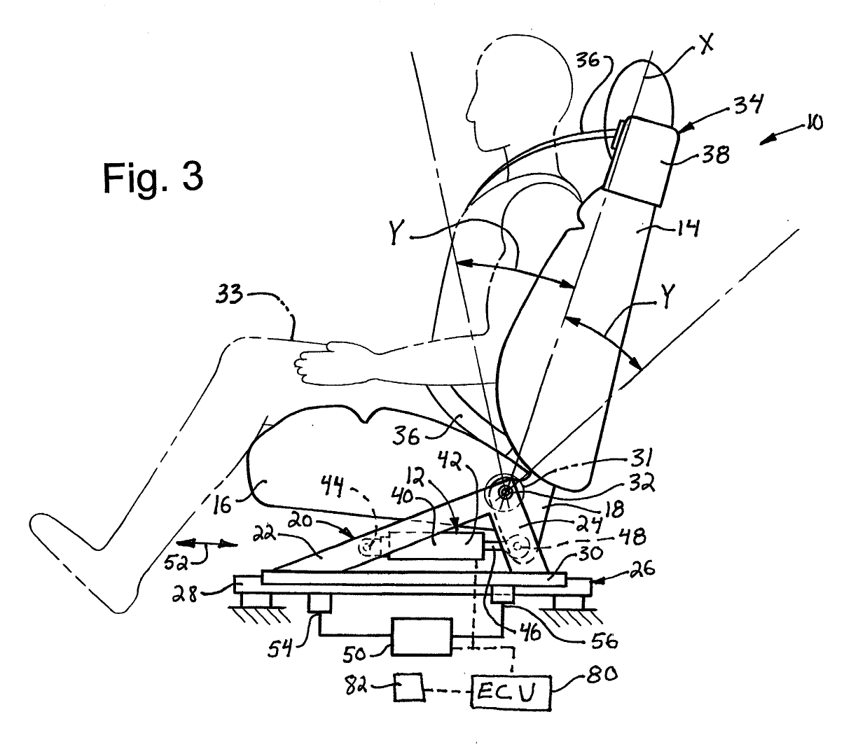

There is illustrated in FIG. 3 a schematic representation of a vehicle seat, indicated generally at 10. The seat 10 includes a first energy management device, indicated schematically at 12, in accordance with the present invention. The seat 10 includes a seat back 14 and seat bottom 16. The seat back 14 has a lower bracket 18 extending downwardly therefrom. The seat 10 includes a bracket assembly 20 including a front bracket 22 and rear bracket 24. The seat bottom 16 is attached to the bracket assembly 20. The bracket assembly 20 is preferably attached to a pair of seat track mechanisms, indicated generally at 26, which provides fore and aft generally horizontal translation of the seat 10. The track mechanisms 26 include lower tracks 28 adapted to be attached to the vehicle floor, and upper tracks 30 attached to the bracket assembly 20. The seat back 14 pivots or rotates about the bracket assembly 20 and the seat bottom 16 at a pivot point 32 about the lower bracket 18 of the seat back 14. The seat 10 may include a recliner mechanism, indicated by phantom lines 31, to provide pivotal adjustment of the seat back 14 relative to the seat bottom 16 to adjust the angle therebetween for the comfort of an occupant, indicated schematically at 33, of the seat 10. The recliner mechanism 31 can be any suitable mechanism which permits adjustment of the angle between the seat back 14 and the seat bottom 16. During an impact or collision wherein the energy management device 12 is utilized, the connection between the seat back 14 and the seat bottom 16 through the recliner mechanism 31 can be disconnected, such as by another unlatching mechanism (not shown), or otherwise bypassed. For example, the recliner mechanism 31 may operate up to a predetermined threshold force wherein the recliner mechanism 31 will maintain the seat back 14 at a desired angle relative to the seat bottom 16 when a force is acted upon the seat back 14 by a force below the threshold value. When the force acting on the seat back 14 is above the threshold value, such as during a relatively severe impact or collision, the force will cause the recliner mechanism 31 to permit movement between the seat back 14 and the seat bottom 16. Alternatively, the recliner mechanism 31 and the energy management device can be incorporated into an integral component.

The seat 10 preferably includes an integral occupant restraint mechanism 34 for generally restraining the occupant 33 to the seat 10, and more particularly to the seat back 14 of the seat 10. The restraint mechanism 34 includes a belt or strap 36 having ends which are operatively fixed to the seat back 14. As shown in FIG. 3, the restraint mechanism 34 can include an upwardly extending tower 38 positioned generally at shoulder height of the occupant 33 for dispensing the strap 36. The restraint mechanism 34 can be a conventional three point restraint mechanism having operatively fixed points about one of the shoulders and either side of the waist of the occupant 33.

The energy management device 12 is schematically illustrated in FIG. 3 in the form of a linear damper or cylinder 40. The energy management device 12 is adapted to be attached between the seat back 14 and the seat bottom or bracket assembly 20 to permit controlled rotational movement of the seat back 14 relative to the seat bottom 16. The cylinder 40 includes a body 42 which is pivotally connected to the front bracket 22 of the bracket assembly 20 of the seat bottom 16 about a pivot point 44. The cylinder 40 includes an arm 46 which translates relative to the body 42. The arm 46 is pivotally attached to the bracket 18 of the seat back 14 at a pivot point 48. Note that the pivot points 32 and 48 are spaced from one another. The arm 46 translates in a resistive manner relative to the velocity of the translation, and provides a damping force or reactionary force. As will be explained below, the cylinder 40 can be actively controlled by effecting the damping characteristics of the cylinder 40 such that the force required to move the arm 46 relative to the body 42 at a desired velocity is altered. Please note that the cylinder 40 is only an example of a structure of an energy management device as described herein, and that any suitable device can also be used for the energy management device 12.

Upon sudden acceleration, such as in an impact, the seat back 14 is subjected to a rotational movement relative to the seat bottom 16 about the pivot point 32. This rotational movement causes the arm 46 of the cylinder to translate in a direction in or out of the body 42. Energy can be dissipated and/or managed through the movement of the arm 46 due to the damping characteristics of the cylinder 40. For example, in a forward impact situation, the seat back 14 is urged forward, leftward as viewing FIG. 3, due to the center of mass of the seat 10 and the occupant 33. The strap 36 of the restraint mechanism 34 restrains the occupant 33 to the seat back 14. As the seat back 14 is urged forward, the seat back pivots in a counterclockwise direction about the pivot point 32, thereby causing the arm 46 to translate out from the body 42. The damping characteristics of the energy management device 12 slows the rotation of the seat back 14 relative to the seat bottom 16. It is generally desirable to translate the seat back a predetermined angle or length (translation) regardless of the severity of the impact forces. For relatively large impact forces, the energy management device 12 should accept a large load within its translation. Contrary, for relatively small impact forces, the energy management device should accept a small load within its translation. For example, as shown in FIG. 3, if the seat back 14 is in angular position indicated by an axis X, it is preferred to allow the seat back 14 to pivot in a forward or rearward direction by an angle Y during the impact event regardless of the severity of the impact forces, or the degree of acceleration. The damping characteristic of the energy management device 12 can be altered to control the movement of the seat back 14 to enable the seat back 14 to pivot about the entire angle Y. Although the angle Y can be any suitable degree which permits limited movement of the seat back to help reduce injury to the occupant 33, it has been found that an angle from about 20 to about 30 degrees is desirable.

The seat 10 may also include a second energy management device, schematically illustrated at 50, for controlling the motion of the seat 10 in a linear orientation in a fore and aft direction, as indicated by a directional arrow 52. The device 50 is attached to the lower and upper tracks 28 and 30 by members 54 and 56, respectively. Upon sudden acceleration, an upper portion of the seat 10 defined by the seat back 14, the seat bottom 16, the bracket assembly 20, and the upper tracks 30 is urged in one of the fore and aft directions 52 by movement of the upper track 30 relative to the lower track 28. The energy management device 50 controls the motion of the upper portion of the seat 10 relative to the vehicle floor in a similar manner as the energy management device 12 described above. Note that the seat 10 can be equipped with one or both of the energy management devices 12 and/or 50. The energy management devices 12 and 50 may also absorb or dissipate some energy, such as through heat due to viscous shear.

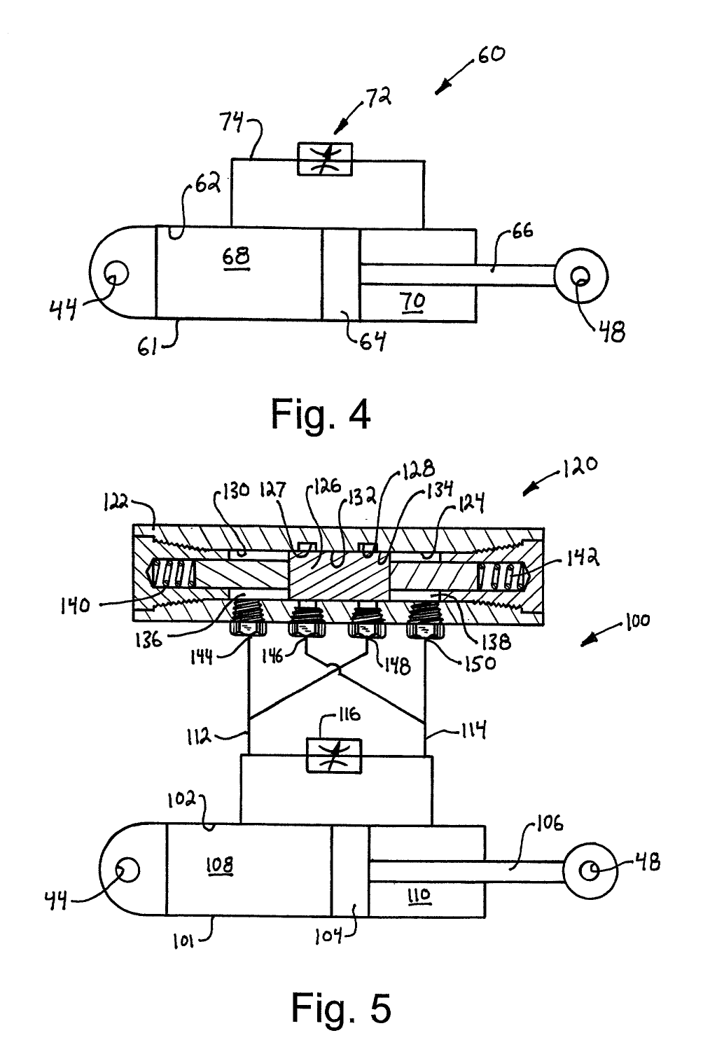

There is illustrated in FIG. 4, a schematic representation of an embodiment of an energy management device, indicated generally at 60. Although the device 60 and other embodiments of energy management devices disclosed herein will be described as being used for the energy management devices 12 of FIG. 3, it should be understood that the device 60 can be used for the device 50 or any other suitable vehicle component. The energy management device 60 is generally in the form of a cylinder, similar to the cylinder 40 described above. The cylinder 60 includes a body 61 having a bore 62 formed therein. A piston 64 is slidably disposed in the bore 62. An arm 66 is attached to the piston 64. The piston 64 and the bore 62 define a pair of chambers 68 and 70 which are preferably filled with a working fluid, such as hydraulic fluid. The cylinder 60 further includes a valve 72 which controls the flow of hydraulic fluid through a conduit 74 in fluid communication with the chambers 68 and 70. Thus, the chambers 68 and 70 are hydraulically linked through the valve 72. The body 61 can be pivotally attached to the bracket assembly 20 at the pivot point 44. The arm 66 can be pivotally attached to the lower bracket 18 of the seat back 14 at the pivot point 48.

Upon an impact force, the arm 66 is moved in a direction towards or away from the body 61, as described above with respect to the device 12. Movement of the arm 66 and the piston 64 causes the fluid from one chamber 68, 70 to flow into the other chamber 70, 68. The cylinder 60 is configured to work in both rotational directions of the seat back 14, and is thus suited for operation in both a frontal and rear collision, as well as other impact situations. A restricted flow of fluid through the valve 72 reduces the acceleration rate of the arm 66 relative to the body of the cylinder 50. Preferably, the device 60, as well as the other energy management devices disclosed herein, can be actively controlled so that the energy dissipating rates relative to time can be altered depending on the severity of the impact forces. For the device 60, the valve 72 can be controlled to change the flow rate therethrough, thereby effecting the rate of acceleration and impact force of the seat 10, as shown in graphical representation in FIGS. 1 and 2 as discussed above. The valve 72 can be any suitable valve structure which can selectively control the flow rate and can be controlled by any suitable manner. For example, the valve 72 may be a solenoid valve wherein the valve is controlled electrically by altering the current directed to the solenoid. The valve 72 may also be mechanically controlled, such as by altering the cross-sectional area of an orifice within the valve 72.

The energy management devices as disclosed herein, such as the devices 12 and 50 and the valve 72, can be controlled by an electronic control unit, indicated schematically at 80 in FIG. 3. The electronic control unit 80 may be connected to a plurality of sensors, indicated schematically at 82, to modify the control of the devices based on information obtained from the sensors. Examples of suitable sensors include an occupant weight sensor, a vehicle speed and/or deceleration/acceleration sensor, a seat deceleration/acceleration sensor, a seat position sensor, an occupant position sensor, a displacement sensor, a load sensor. One or more of the sensors may be used to impact the control of the energy absorbing device. The seat position sensor detects the fore/aft position of the seat 10 and/or the recline angle Y of the seat back 14 to determine the permissible length of movement or deflection that can be taken due to the space constraints in the interior of the vehicle. The displacement sensor and the load sensor can be connected to the energy management devices themselves to determine the movement and load of the device itself. It is contemplated that the output from some of the desired sensors 82 may be available by using sensors already in place in the vehicle which are used for other vehicle systems. For example, the desired seat position sensor may already be used in a power seat mechanism. In another example, an occupant weight sensor may be used in a vehicle air bag or curtain restraint system to determine if the air bag is to be deployed or not depending on the presence of an occupant. Vehicle speed and acceleration sensors may be used in the vehicle's stability braking system.

There are various types of control strategies which may be employed for controlling the energy management devices. One such example is “feed forward” control strategy. Control of the energy management devices under a feed forward control strategy determines how the device should behave in the future based on external information known at the present time. The various sensors as described above can supply information of initial conditions and impact severity to the electronic control unit 80 which determines a required response. The initial conditions can be the sensing of an imminent impact, such as with a proximity sensor. The proximity sensor 96 may use radar for detecting an impending impact with another vehicle or obstacle prior to the actual impact. An advantage of using a proximity sensor is that a greater amount of time is available to control the energy management device, and thus devices having a relatively long reacting period may still be utilized. Alternatively, the impact may be sensed at the time of the impact, such as by the vehicle speed acceleration sensor. The sensing of the impact may also be determined by the seat acceleration sensor.

Another example of a control strategy is a “feed back” control strategy. Control of the energy management devices under a feed back control strategy attempts to modify the device's response in real time based on factors which directly effect it. For example, input from the displacement sensor and the load sensor may be used and adjustments can be made accordingly. It is also contemplated that some energy management devices may be “self-adaptive” in that the operation of the device responds automatically to load or displacement inputs. Thus, an electronic control unit 80 and sensor 82 may not be required to actively control the energy management device because of its self-adaptive response to an input, such as load or displacement.

There is illustrated in FIG. 5, a schematic representation of another example embodiment of an energy management device, indicated generally at 100. The device 100 is generally in form of a cylinder, similar to the cylinder 40 of FIG. 3.

The cylinder 100 includes a body 101 having a bore 102 formed therein. A piston 104 is slidably disposed in the bore 102. An arm 106 is attached to the piston 104.

The body 101 can be pivotally attached to the bracket assembly 20 at the pivot point 44. The arm 106 can be pivotally attached to the lower bracket 18 of the seat back 14 at the pivot point 48. The piston 104 and the bore 102 define a pair of chambers 108 and 110 which are preferably filled with a working fluid, such as hydraulic fluid. The device 100 furthers includes a conduit 112 in fluid communication with the chamber 108. A conduit 114 is in fluid communication with the chamber 110. The device 100 preferably includes a control valve 116 in fluid communication between the conduits 112 and 114. The valve 116 may be similar to the valve 72 described above. The valve 116 controls the flow of hydraulic fluid through the conduits 112 and 114, and thus between the chambers 108 and 110. Thus, the chambers 108 and 110 are hydraulically linked through the valve 116.

The device 100 preferably further includes a spool valve, schematically illustrated at 120. Any type of spool valve design may be used for the spool valve 120. The valve 120 includes a housing 122 having a stepped bore 124 formed therein. A spool 126 is slidably disposed in the bore 124. A pair of circumferential grooves 127 and 128 are formed in the bore 124 to define a first land 130, a second land 132, and a third land 134. The bore 124 and the spool 126 define a first chamber 136 and a second chamber 138. The first chamber 136 is in fluid communication with the conduit 112. The second chamber 138 is in fluid communication with the conduit 114. The spool 126 is centrally biased in the bore 124 by a pair of springs 140 and 142. The spool valve 120 includes four ports 144, 146, 148, 150. Ports 144 and 148 are in fluid communication with a portion of the conduit 112 on one side of the valve 120. Ports 146 and 150 are in fluid communication with a portion of the conduit 14 on the other side of the valve 120.

The valve 116 and the spool valve 120 cooperate to provide a self-adaptive damper by using pressure balancing. In an impact situation, the piston 104 will move within the bore 102 of the body 11 causing an increase in pressure in one of the chambers 108 and 110. Fluid pressure will build up in one of the chambers 136 or 138 due to an increase in pressure from the chambers 108 or 110, respectively, caused by movement of the piston 104. This pressure increase creates a force acting against one of the faces of the spool 126 to move the spool either rightward or leftward, as viewing FIG. 5 against the biasing of the spring 140 or 142. Sufficient movement of the spool 126 will cause an end of the spool 126 to move past a respective edge of one of the lands 130 and 134, thereby opening communication between the chambers 136 or 138 with one of the grooves 127 or 128, respectively. One of the chambers 136 or 138 will then be in fluid communication between the chamber 108 and 110 of the device. The device 100 is self-adaptive in that the device 100 controls the damping characteristics of the device 100 relative to the duration of the impact depending on the rate of acceleration through the use of the pressure controlled spool valve 120. The end of the spool 126 and corresponding edge of the lands 130 and 134 essentially functions as an orifice which can be sized so as to permit a controlled damping characteristic.

The control valve 116 (and the valve 72 of the device 60 of FIG. 4) can be used to adjust the recline angle of the seat back 14 relative to the seat bottom 16. To accomplish this, the valve 116 can be operated to an open position to permit fluid communication between the chambers 108 and 110 via the conduits 112 and 114. With the valve 116 in its open position, the piston 104 is forced to move within the bore 102 and, therefore, the arm 1066 is movable relative to the body 101. If the device 100 is connected to the seat 10 in a similar manner as the device 12 of FIG. 3, movement of the arm 106 relative to the body 101 will alter the angle of the seat back 14.

The device 100 can also be actively controlled by controlling the control valve 116. With the control valve 116 being in parallel with the spool valve 120, the pressure which the valve 116 opens can be directly controlled by regulating the control valve 116. The control valve 116 can be a standard needle valve, which has the capability of accurately regulating flow with a relatively small error. This control valve 116 will preferably let the pressure slightly build up in the system before the system is enabled. The pressure at which the spool valve 120 begins to open will generally depend on what pressure the control valve 116 is set at.

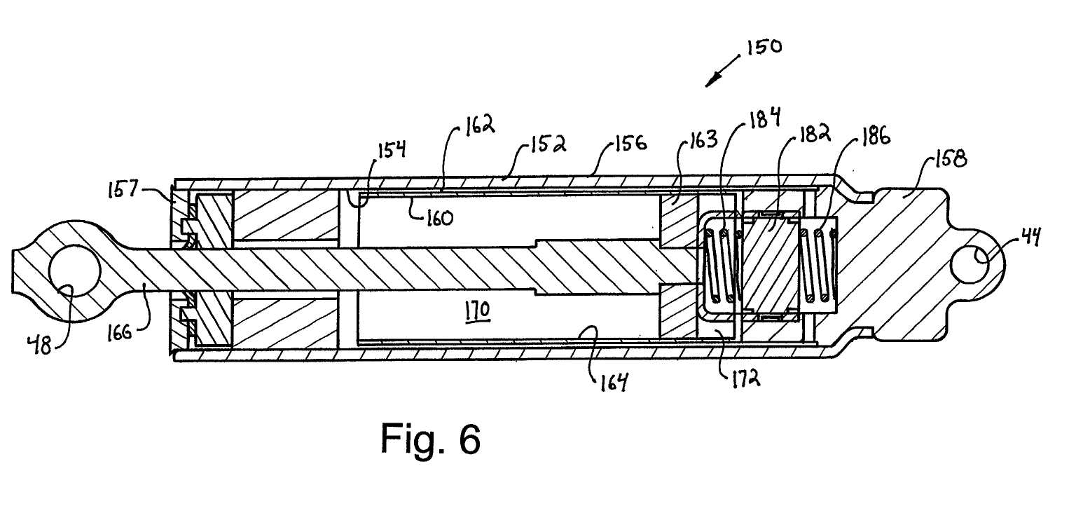

There is illustrated in FIG. 6, a schematic representation of another example embodiment of an energy management device, indicated generally at 150. The device 150 is generally in form of a cylinder. As will be explained below, the device 150 is self-adaptive in that the device 150 automatically is controlled by an input pressure to control the motion of the seat back 14 through a duration of time during rapid acceleration thereof, thereby reducing peak acceleration forces acting on the seat 10 and occupant.

The device 150 includes a multi-component body 152 defining a bore 154 formed therein. The body 152 includes a tube 156, a cap 157 for generally closing of one end of the tube 156, and a rear mount 158 for closing off the other end of the tube 156. A relatively thin walled tubular sleeve 160 is disposed in the bore 154. A plurality of longitudinally extending grooves 162 are formed in the outer surface of the sleeve 160. A piston 163 is slidably disposed in a bore 164 of the sleeve 160. An arm 166 is attached to the piston 162. The rear mount 158 of the body 152 can be pivotally attached to the bracket assembly 20 at the pivot point 44. The arm 166 can be pivotally attached to the lower bracket 18 of the seat back 14 at the pivot point 48. The piston 162 and the bore 164 generally define a pair of chambers 170 and 172. The grooves 162 formed in the sleeve 160 function as part of a conduit for fluid communication between the chambers 170 and 172.

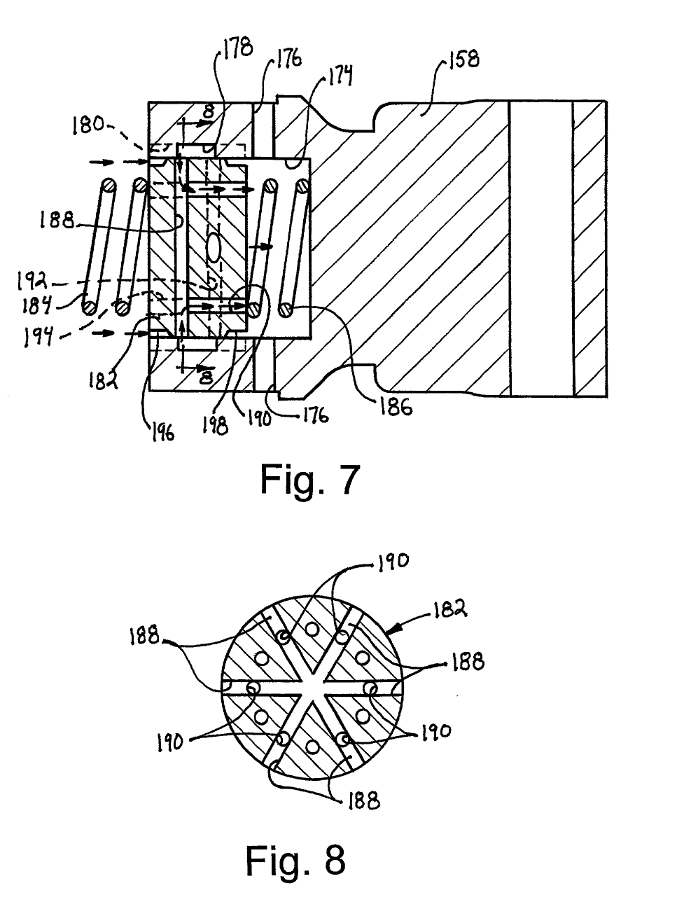

As best shown in FIG. 7, the rear mount 158 includes a bore 174 formed therein. The rear mount 158 also has a plurality of radially extending passageways 176 formed therein which are in fluid communication with the bore 174 and the conduit defined by the grooves 162 of the sleeve 160. An inner radially extending groove 178 is formed in the bore 174. Preferably, the rear mount 158 also includes longitudinally extending grooves 180 formed therein adjacent the groove 178 to provide restricted fluid communication between the chambers 170 and 172.

A valve member 182 is slidably disposed in the bore 174. The valve member 182 is centrally biased within the bore 174 by a pair of springs 184 and 186 disposed on opposing sides of the valve member 182. The valve member 182 includes a plurality of “spoke-like” radially extending passageways 188, as shown in FIGS. 7 and 8. The valve member 182 further includes a plurality of longitudinally extending passageways 190 in communication with the passageways 188. The passageways 188 and 190 provide a first set of flow paths for fluid communication between the chamber 170 and 172 via the radially extending passageways 178 of the rear mount 158 and the grooves 162 of the sleeve 160. The valve member 182 also includes a second set of flow paths defined by a plurality of “spoke-like” radially extending passageways 192 and a plurality of longitudinally extending passageways 194. The two sets of flow paths and symmetry of the device 150 provide operation of the valve member 182 in either direction, i.e., for either longitudinally direction of the arm 166 relative to the body 152. The ends of the valve member 182 include reduced diameter portions 196 and 198.

In operation of the device 150, the arm 166 may move in a rightward direction, for example, as viewing FIG. 6. Note that the arm 166 is shown in its full rightward stroke in FIG. 6, and it is contemplated that the piston 163 will be more centrally located within the sleeve 160 during normal use of the device 150. Movement of the arm 166 causes the piston 163 to compress the chamber 172 and therefore increase the pressure within the chamber 172. Fluid can flow from the chamber 172 to the chamber 170 via one of the sets of flow paths, as indicated by directional flow arrows in FIG. 7, and the passageways 176 formed in the rear mount 158 and the grooves 162 formed in the sleeve 160. The device is controlled in a self-adaptive manner in that the input pressure acting on the face of the valve member 182 causes longitudinal movement thereof to permit the flow through the flow paths effectively acting like a restricted orifice. This operation is similar to the spool valve device 100, as shown in FIG. 5. More specifically, as the valve member 182 moves, fluid is directed across the reduced diameter portion 196 of the valve member 182 and into the groove 178 and through passageways 188 and 190. Although it is contemplated to configure the device 150 such that the flow path is either closed or open, a restricted flow can be determined by the distance of the valve member 182 relative to the groove 178. A restricted flow may also be determined by the closing off of one of the two passageways 188 and 192.

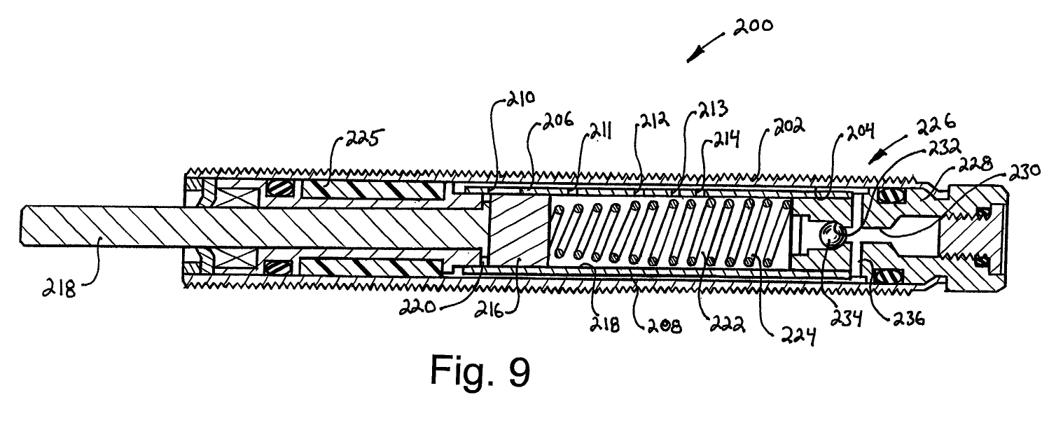

There is illustrated in FIG. 9, a schematic representation of another embodiment of an energy management device, indicated generally at 200. The device 200 is generally in the form of a cylinder. As will be explained below, the device 200 is self-adaptive in that the device 200 automatically is controlled by the piston location along the length of the stroke of the device 200, thereby reducing peak acceleration forces acting on the seat 10 and occupant.

The device 200 includes a body 202 which can be connected to one of the bracket assembly 20 and lower bracket 18, as discussed above relative to the device 12, for example. The body 202 defines a bore 204. A sleeve 206 is disposed in the bore 204. Preferably, the sleeve 206 includes longitudinal grooves 208 formed in an outer surface thereof to provide for a fluid conduit, as will be discussed below. The sleeve 206 includes a plurality of radially passageways formed therein. The embodiment of the sleeve 206 illustrated in FIG. 9, includes five passageways 210, 211, 212, 213, and 214. The passageways 210, 211, 212, 213, and 214 can have any width and can have any spacing therebetween.

The device 200 further includes a piston 216 slidably disposed in a bore 218 formed in the sleeve 206. An arm 218 is attached to the piston 216. The arm 218 can be attached to either one of the bracket assembly 20 and lower bracket 18, opposite of the body 202. Opposing sides of the piston 216 define a pair of chambers 220 and 222 which are in fluid communication with each other via the grooves 208 formed in the sleeve 206 and selected ones of the plurality of passageways 210, 211, 212, 213, and 214. A spring 224 biases the piston 216 and arm 218 in a leftward direction, as viewing FIG. 9, to decrease the volume of the chamber 220. The device 200 may also include a fluid accumulator 225 to account for displaced fluid as the arm 218 enters and exits the body 202. Although the device 200 is generally configured for a unidirectional movement of the arm 218 in an impact situation (rightward as viewing FIG. 9), the device 200 could be configured to operate in both directions.

The device 200 preferably includes a ball valve assembly, indicated generally at 226. A housing 228 generally closes off one end of the device 200. The housing includes a stepped bore 230 including a valve seat 232 which cooperates with a ball 234. Radially extending passageways 236 are formed in the housing 228 to provide fluid communication between the bore 230 and the conduit defined by the longitudinal grooves 208 formed in the sleeve 206. The valve assembly 226 generally restricts or prevents the flow of fluid from the chamber 222 to the chamber 220 through the valve assembly 226, and permits the flow of fluid from the chamber 220 to the chamber 222, such as in a return stroke after actuation of the device 200.

In operation of the device during an impact situation, the arm 218 may move in a rightward direction, for example as viewing FIG. 9. Movement of the arm 218 causes the piston 216 to compress the chamber 222 and therefore increase the pressure within the chamber 222. Fluid can flow from the chamber 222 to the chamber 220 via the passageways 211, 212, 213, and 214 through the conduit defined by the grooves 208 and through the passageway 210. The passageways 211, 212, 213, and 214 function as restricted orifices to control the reaction force of the arm 218 relative to the body 202. Note that during movement of the piston 216 in the rightward direction, as viewing FIG. 9, will cause the ball 234 to remain on the seat 232 thereby preventing fluid flow through the bore 230. Further movement of the arm 218 and piston 220 will eventually close off the passageway 211, thereby only allowing fluid to flow through the passageways 212, 212, and 213 from the chamber 222. Thus, the area of the fluid flow is reduced, thereby controlling the reaction force of the arm 218 relative to the body 202. By controlling the reaction force, the acceleration rate can be controlled. Further movement of the arm 218 and piston 220 will eventually close of the passageways 212 and 213. Thus, the device 200 is self-adaptive in that the device 200 automatically is controlled by the location of the piston 216 along the length of the stroke of the device 200, because of the sequential closing off of the passageways 211, 212, and 213. Generally, the greater the impact force acting on the device 200, the longer the stroke length of the arm 218.

If desired, the bore 230 could be configured as a restricted orifice so that on return stroke of the arm 218, the flow of fluid is restricted through the bore 230 to provide a controlled reaction force on the arm 218.

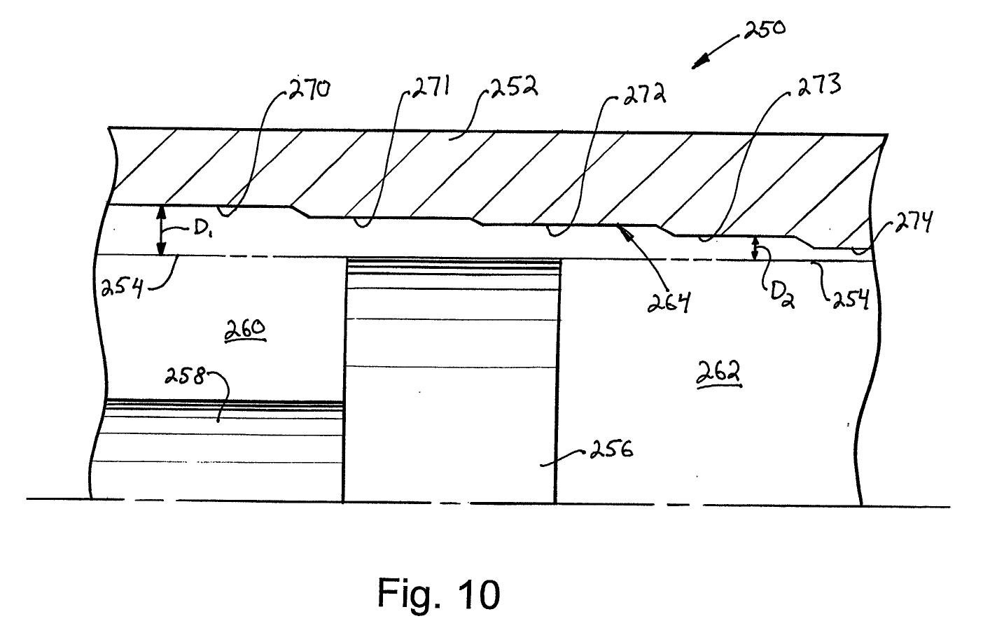

The device 200 of FIG. 9 used a plurality of passageways 211, 212, and 213 which are sequentially eliminated or reduced during the stroke length of the arm 218 to control the effective orifice size for the flow of fluid. By reducing the effective orifice size, the reaction force of the arm 218 can be increased relative to travel of the piston 216 along the stroke length, and therefore relative to time. Instead of using a plurality of passageways, the effective orifice size of an energy management device can be controlled by other ways. For example, there is illustrated in FIG. 10 and enlarged view of an energy management device 250 which is in the form of a cylinder, and uses a wall profile to control the effective orifice size.

The device 250 includes a body 252 which can be connected to one of the bracket assembly 20 and lower bracket 18, as discussed above relative to the device 12, for example. The body 252 defines a cylindrical bore, indicated by phantom lines 254. A piston 256 is slidably disposed in the bore 254. An arm 258 is attached to the piston 256. The arm 258 can be attached to the other of the bracket assembly 20 and lower bracket 18, opposite of the body 252. Opposing sides of the piston 256 define a pair of chambers 260 and 262 which are in fluid communication with each other via a stepped longitudinal groove, indicated generally at 264, formed in the wall of the bore 254. The groove 264 includes a plurality of stepped portions 270, 271, 272, 273, and 274 having depths which are, for example, sequentially reduced from left to right, as viewing FIG. 10. The depths of the portions are related to the flow area or effective orifice size of the flow of fluid between the chambers 260 and 262. For example, the depth D₁ of the portion 270 is greater than the depth D₂ of the portion 273. The portion 270 has a greater cross-sectional area to permit a greater flow of fluid than the cross-sectional area of the portion 273. Of course, the groove 264 can have any profile for controlling the flow of fluid in a controlled manner.

In operation of the device 250 during an impact situation, the arm 258 may move in a rightward direction, for example as viewing FIG. 10. Movement of the arm 258 causes the piston 256 to compress the chamber 262 and therefore increase the pressure within the chamber 262. Fluid can flow from the chamber 262 to the chamber 260 via the groove 264. When the piston 256 is more leftward, as viewing FIG. 10, flow can flow around the piston 256 and through the portions 270 and 271 which have a relatively larger cross-sectional area, thereby permitting the piston 256 and arm 258 to travel rightward at a relatively high rate of velocity. However, when the piston 256 is more rightward, as viewing FIG. 10, flow can flow around the piston 256 through the portions 273 and 274, thereby reducing the effective cross-sectional area to reduce the rate of velocity. Thus, the device 250 is self-adaptive in that the device 250 automatically is controlled by the location of the piston 216 along the stroke length, because of the changing cross-sectional areas of the portions 270, 271, 272, 273, and 274.

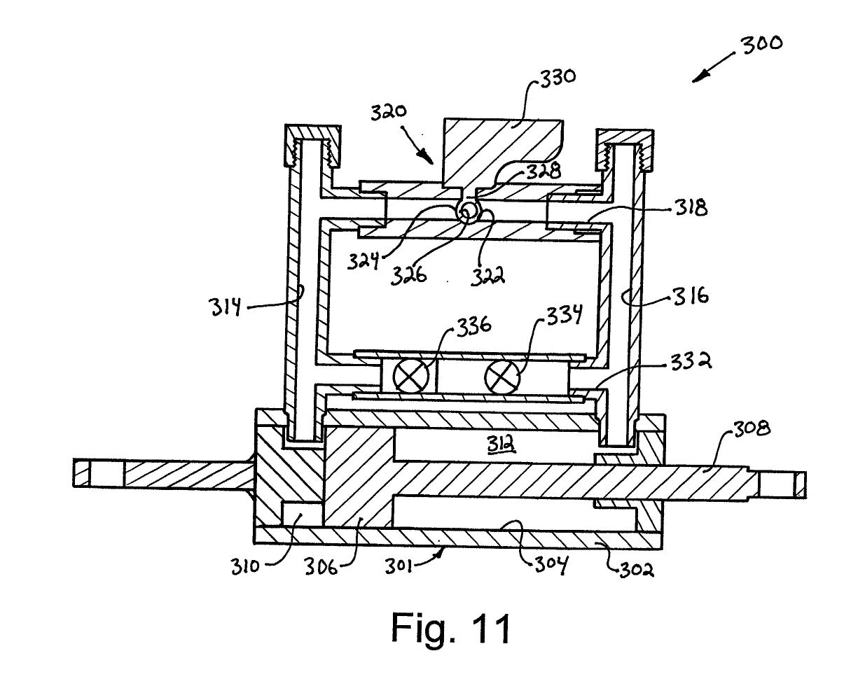

There is illustrated in FIG. 11 another embodiment of an energy management device, indicated generally at 300. The device 300 is generally in the form of a cylinder with a plurality of valves.

The device 300 includes a cylinder assembly, indicated generally at 301, similar to the cylinder 60 of FIG. 4. The cylinder assembly 301 includes a body 302 which can be connected to one of the bracket assembly 20 and lower bracket 18, as discussed above relative to the device 12, for example. The body 302 defines a bore 304. A piston 306 is slidably disposed in the bore 304. An arm 308 is attached to the piston 306. The arm 308 can be attached to either one of the bracket assembly 20 and lower bracket 18, opposite of the body 302. Opposing sides of the piston 306 define a pair of chambers 310 and 312. A conduit 314 is in fluid communication with the chamber 310. A conduit 316 is in fluid communication with the chamber 312.

A conduit 318 is in fluid communication with the conduits 314 and 316. A valve 320 is disposed in the conduit 318. The valve 320 can be in the form of a ball valve. For example, the valve 320 can include a generally spherical valve seat 322 formed in the conduit 318. A ball 324 is disposed in the seat 322. The ball 324 includes a bore 326 formed therethrough. An arm 328 extends from the ball 324 and is connected to a handle 330. The ball valve 320 can be manually operated through movement of the handle 330. The ball 324 can be operated between an open and a closed position. In the closed position, the ball 324 is moved so that the bore 326 is not in fluid communication with the conduit 318, as shown in FIG. 11, thereby preventing fluid flow between the chambers 310 and 312 via the conduit 318. In the open position, the ball 324 is moved so that the bore 326 is in fluid communication with the conduit 318, thereby permitting the flow of fluid between the chamber 310 and 312 via the conduit 318. In the closed position, as shown in FIG. 11, fluid is restricted from flowing though the conduit 318, thereby preventing movement of the arm 308 relative to the body 302 of the cylinder 301 by hydraulically locking the cylinder 301. Thus, an occupant of the seat to which the device 300 is installed can adjust the recline angle of the seat back 14 relative to the seat bottom 16 by turning the handle 330 to open the ball valve 320, and then locking the position of the seat back 14 by closing the ball valve 320.

The device 300 further includes a conduit 332 in fluid communication with the conduits 314 and 316. Preferably a pressure compensated flow valve, schematically illustrated at 334, is disposed in the conduit 332. The device can further include a pressure relief valve 336 disposed in the conduit 332. Preferably the relief valve 336 is in series within the conduit 332 relative to the pressure compensated flow valve 334. The pressure compensated flow control valve 334 can be any suitable valve structure and preferably uses the flow pressure through the valve 334 to self adjust its operating orifice. Generally, the greater the pressure, the smaller the orifice size. The pressure relief valve 336 generally prevents the flow of fluid through the conduit 332 until a threshold load is reached, e.g., the load value corresponding to an impact situation. At this load, the pressure relief valve 336 opens and the pressure compensated flow valve 334 provides controlled flow through the conduit 334 to provide damping. The pressure compensated flow valve 334 can be any suitable valve arrangement as described with respect to the energy management devices disclosed herein. Alternatively, the valve 334 can be electrically controlled by a solenoid to adjust the flow control or effective orifice size of the valve 334. The ball valve 320, the pressure compensated flow valve 334, and the pressure relief valve 336 can be integrated into one assembly if so desired.

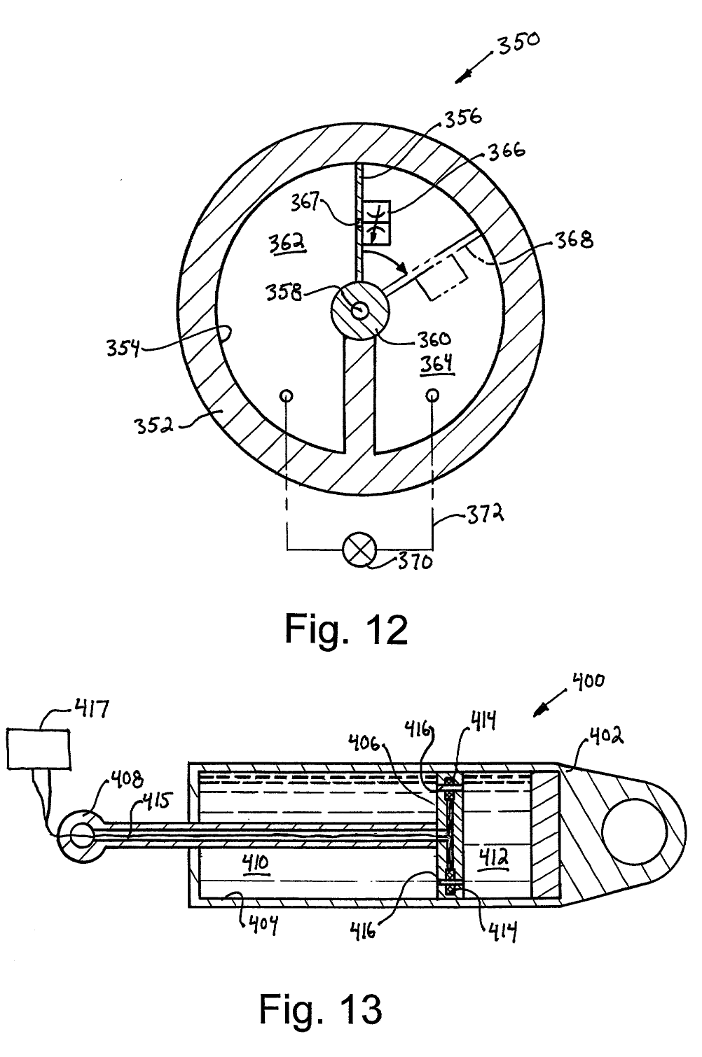

There is schematically illustrated in FIG. 12 another embodiment of an energy management device, indicated schematically at 350. The energy management device 350 functions similarly to the linear cylinder device 60 illustrated in FIG. 4, but is in the form of a rotary damper using rotational movement to control the flow of hydraulic fluid instead of a linear piston/cylinder arrangement.

The device 350 includes a body 352 defining an arcuate cavity 354 filled with fluid, such as hydraulic fluid. A vane 356, or a plurality of vanes, is pivotally mounted about a pivot 358. The vane 356 can be connected to a member 360 which pivots about the pivot 358 and extends outwardly from the cavity 354. The vane 356 separates the cavity 354 into a pair of chambers 362 and 364. The body 352 can be connected to one of the bracket assembly 20 and lower bracket 18, as discussed above relative to the device 12, for example. The member 360 can be connected to the other of the bracket assembly 20 and lower bracket 18.

In one embodiment of the invention, the vane 356 includes a passageway 367 for providing selective communication between the chambers 362 and 364. The device 350 includes a valve, indicated schematically at 366, mounted on the vane 356 adjacent the passageway 367 for controlling the flow of fluid through the passageway 366 between the chambers 362 and 364. The valve 366 is similar to the valve 72 of the device 60 of FIG. 4, and can be any suitable valve arrangement. If desired the valve 366 may be positioned elsewhere and not on the vane 356, such as for example in a conduit connecting the chambers 362 and 364.

In operation during an impact force, the vane 356 will pivot about the pivot 358 compressing one of the chambers 362 and 364, depending on the directional rotation of the vane, and therefore increase the pressure within that chamber. Note that the device 350 is bi-directional and will function as a damper mechanism with either rotational direction of the seat back 14 if mounted thereon. The valve 366 can be controlled to regulate the flow of fluid between the chambers 362 and 364 to provide desired damping. The vane 356 can move to any position within the arcuate cavity 354, as illustrated by broken lines 368, thereby permitting rotational movement of the seat back 14. One of the advantages of the device 350 is a reduced bulk or length to improve on packaging constraints for incorporating the device into a vehicle seat. For example, the device 350 could be mounted at the pivot point 32 for the seat back 14, as shown in FIG. 3.

The device may also include a valve 370, which functions in a similar manner as the ball valve 320 of the device 300 illustrated in FIG. 11, for providing a seat recliner mechanism to selectively position and maintain the seat back 14 at any desired position. A conduit, represented by phantom lines 372, provide fluid communication between the chambers 362 and 364. The valve 370 is positioned within the conduit 372. The valve 370 is operable between open and closed positions. In the open position, the valve 370 permits the flow of fluid between the chamber 362 and 364 via the conduit 372. In the closed position, fluid is restricted from flowing though the conduit 372, thereby preventing movement of the member 360 relative to the body 352 by hydraulically locking the cavity 354. Thus, an occupant of the seat to which the device 350 is installed can adjust the recline angle of the seat back 14 relative to the seat bottom 16 by controlling the valve 370. The valve 370 can be any suitable valve structure.

There is schematically illustrated in FIG. 13 another embodiment of an energy management device, indicated schematically at 400. The device 400 is in the form of a cylinder, similar to the cylinder 40 of FIG. 3. The device 400 includes a body 402 having a bore 404 formed therein. A piston 406 is slidably disposed within the bore 404. An arm 408 is attached to the piston 406. The one end of the body 402 can be pivotally attached to the one of the bracket assembly 20 and lower bracket 18. The arm 408 can be pivotally attached to the other one of the bracket assembly 20 and lower bracket 18. The piston 406 and the bore 404 define a pair of chambers 410 and 412.

Preferably, the device 400 uses a magneto-rheological fluid as the working fluid within the chambers 410 and 412. The magneto-rheological fluid contains ferromagnetic particles suspended within a base fluid. Magneto-rheological fluids are essentially suspensions of micron-sized, magnetizable particles in a carrier fluid. Under normal conditions, magneto-rheological fluid is a free-flowing liquid. However, exposure to a magnetic field can transform the fluid into a near-solid in milliseconds. The fluid can be returned to its liquid state with the removal of the field. When the fluid is exposed to a magnetic field, the effective viscosity of the fluid is changed. Thus, the effective viscosity of the fluid can be actively changed by controlling the presence and strength of a magnetic field. To provide a controlled magnetic field, the device includes one or more magnetic chokes or electromagnets 414. The electromagnets 414 are preferably housed within the piston 406. The electromagnets 414 can be electrically connected to a control unit 417 by wires 415 disposed through bores formed in the piston 406 and arm 408. The electromagnets 414, in one example, are positioned adjacent passageways 416 formed through the piston 406. The magnetic choke can be positioned at any suitable location where fluid flow between the chambers 410 and 412 exists. For example, the magnetic choke may be separate from the body 402 of the device 400 and could be located in a similar manner as the valve 72 in the device 60 of FIG. 4. The passageways 416 provide fluid communication between the chambers 410 and 412. During operation of the device in an impact situation when the piston 406 is travelling within the bore 404, the control unit 417 can send an appropriate signal to the electromagnets 414 to produce a magnetic field to alter the effective viscosity of the fluid through the passageways 416, thereby effecting the damping characteristics of the device 400.

The device 400 may alternatively use electro-rheological fluid as the working fluid and components (not shown) instead of the electromagnets 414 to provide an electric field which alters the effective viscosity of the electro-rheological fluid in a similar manner as a magnetic field with the magneto-rheological fluid.

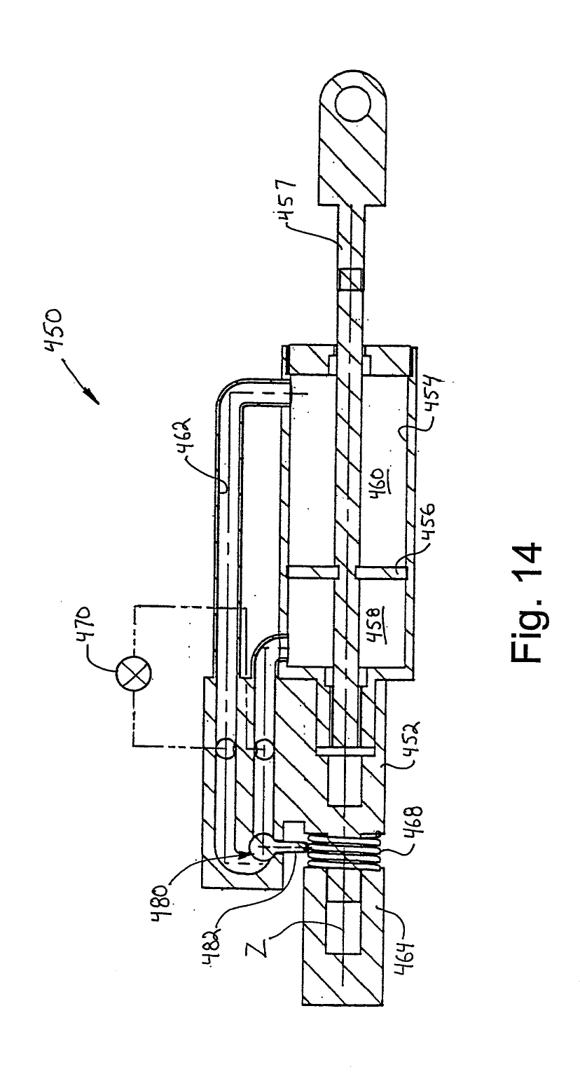

There is schematically illustrated in FIG. 14 another embodiment of an energy management device, indicated schematically at 450. The energy management device 450 is in the form of a cylinder and includes a body 452 defining a bore 454 formed therein. A piston 456 is slidably disposed in the bore 454. An arm 457 is attached to the piston 456. The piston 456 and the bore 454 define a pair of chambers 458 and 460 which are preferably filled with a working fluid, such as hydraulic fluid. A conduit 462 provides selective fluid communication between the chambers 458 and 460, as will be explained below.

The device 450 further includes a sliding member 464 slidably engaged with an end 466 of the body 452. The sliding member 464 is preferably mounted for linear movement about an axis Z which is preferably coaxial with the linear movement of the arm 457 relative to the body 452. The sliding member 464 is connected with an end of a spring 468. The other end of the spring 468 is connected with the body 452. The spring 468 can be any suitable spring structure, such as a coil spring. The sliding member 464 can be connected with one of the bracket assembly 20 and lower bracket 18. The arm 456 can be connected with the other of the bracket assembly 20 and lower bracket 18. The spring 468 is preferably mounted such that the spring 468 can be compressed or extended to provide motion of the sliding member 464 relative to the body 452 in either direction. The spring 468 is preferably a spring with a relatively high spring constant so that the spring 468 is not significantly compressed or extended during normal use of the seat 10, e.g., not during an impact situation. Therefore, during normal driving conditions and during adjustment of the reclining feature of the seat back 14, the body 452 and sliding member 464 are preferably fixed relative to one another.

The device preferably includes a valve, shown schematically at 470, which functions in a similar manner as the ball valve 320 of the device 300 illustrated in FIG. 11, for providing a seat recliner mechanism to selectively position and maintain the seat back 14 at any desired position. The valve 470 is positioned within the conduit 462. The valve 470 is preferably normally closed and operable between open and closed positions, such as by manual operation by the occupant of the seat. In the open position, the valve 470 permits the flow of fluid between the chambers 458 and 460 via the conduit 462. In the closed position, fluid is restricted from flowing though the conduit 462, thereby preventing movement of the arm 457 relative to the body 452 by hydraulically locking the chambers 458 and 460. Thus, an occupant of the seat to which the device 450 is installed can adjust the recline angle of the seat back 14 relative to the seat bottom 16 by controlling the valve 470. The valve 470 can be any suitable valve structure.

The device 450 preferably also includes a valve, indicated schematically at 480, connected in a parallel arrangement relative to the valve 470 via the conduit 462. Thus, the valves 470 and 480 can be used independently of each other. The portion of the valve 480 which controls the flow of fluid through the conduit 462 is preferably housed in a fixed relationship relative to the body 452. The valve 480 further includes an actuating arm 482 which is mechanically engaged with the spring 468. Alternatively, the arm 482 could be connected to a portion of the sliding member 464. Movement of the arm 482 operates the valve between a closed position and various open positions depending on the degree of movement of the arm relative to the body 452. In the closed position, the valve 480 preferably prevents fluid from flowing through the conduit 462, thereby hydraulically locking the chambers 458 and 460 and preventing movement of the arm 457 relative to the body 452. During an impact situation in which there is a sufficient threshold force acting on the arm 457 and the sliding member 464 to overcome the static spring force, the spring will either compress or expand and the sliding member 464 will move relative to the body 452. Movement of the spring 468 will cause movement of the actuating arm 482. Movement of the actuating arm 482 will cause the valve 480 to permit fluid to exit one of the chambers 458 and 460 to the other one of the chambers 460 and 458 via the conduit 462 in a controlled manner. The flow of fluid between the chambers 458 and 460 permits the arm 457 to move relative to the body 452 and the sliding member 464. Preferably, the sliding member 464 moves a relatively small distance relative to the body 452 compared to the travel of the arm 457 relative to the body 452. The valve 480 can be operated by any suitable manner, such as by opening a desired orifice size to allow the flow of fluid therethrough. The orifice size of the valve 480 preferably corresponds proportionally to the travel and movement of the actuating arm 482. By controlling the orifice size, the device 450 can control the resistive force of the arm 457 relative to the body 452. Thus, the device 450 is self-adaptive in that the force imparted on the device 450 via the arm 457 and the sliding member 464 directly corresponds to the opening of the valve 480 which automatically controls the resistive force of the arm 457 relative to the body 452. The energy dissipating rates relative to time can be altered depending on the severity of the impact force. The compressive and extending mounting of the spring 468 provides bi-directional control of the seat back 14 such that the device 450 functions in either rotational direction of the seat back 14.

Although some of the valve-type energy management devices described above use an input pressure, or input force, or inertia to control the devices, other input criteria can also be used. For example, the devices 12 and 50 can be configured to react based upon the velocity or speed at which reaction force is generated on their respective arms relative to the body for the purpose of lowering occupant reaction forces and acceleration. For example, these types of self-adaptive dampers or cylinders can sample the force or velocity during an initial percentage of travel of the arm, such as the first 3 percent, and mechanically or electrically react with a desired resistance according to the force or velocity information. One such commercially available self-adaptive fluid damper is manufactured by Taylor Devices, Inc., and sold under Model W-Series Fluidicshoks.

Although the embodiments of the energy management devices described and illustrated above in FIGS. 4 through 14 use various hydraulic valve configurations for controlling the motion of a component such as the seat back 14, other non-hydraulic mechanisms can be used to control the motion of the seat back 14. For example, the motion of the seat back 14 can be controlled by metal working or deformation of a relatively solid member operatively connected to the seat back 14. By controlling the amount of material being worked or deformed, the mechanisms can control the motion of the seat back 14 through a duration of time during relative rapid acceleration of the vehicle.

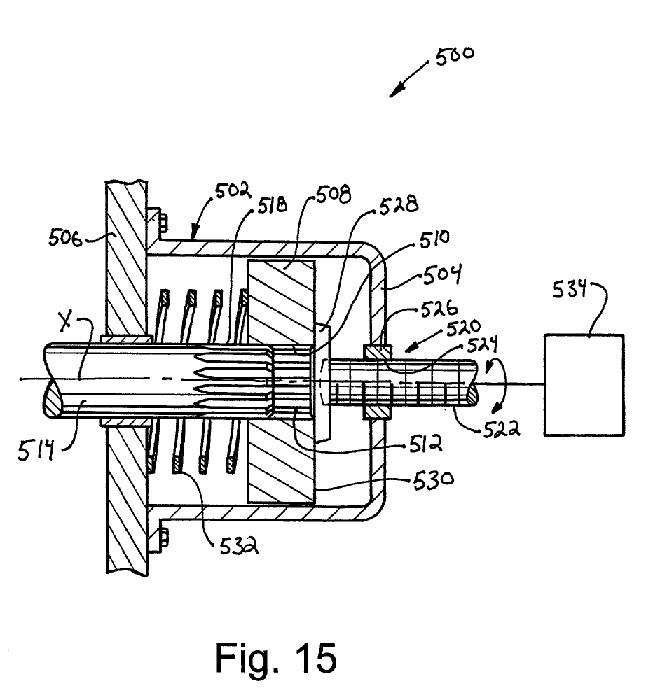

There is illustrated in FIG. 15, another embodiment of an energy management device, indicated generally at 500. The device 500 generally uses deformation of a relative solid yet deformable material to control the motion of two components, such as the seat back 14 relative to the seat bottom 16. As will be described below, the device 500 can also be used to function as a recliner mechanism for rotational adjustment of the seat back 14 relative to the seat bottom 16.

The device 500 includes a housing, indicated generally at 502. The housing can be comprised of a cover 504 mounted on a mounting plate 506. A block 508 is slidably mounted within the interior of the cover 504. Preferably, the block 508 and cover 504 have complimentary cross-sectional shapes so that the block 508 is permitted to move linearly within the interior of the cover 504 about an axis X, but is prevented from rotational movement therein. For example, the block 508 and cover 504 could have rectangular cross-sectional shapes. The block 508 includes a bore 510 having one or more splines 512 formed therein. Preferably, the splines 512 extend in a direction parallel to the axis X. A shaft 514 extends through an opening 516 of the mounting plate 506. The shaft 514 has an end having externally formed splines 518 formed thereon which mate with the internal splines 512 of the block 508. Due to the splined arrangement, the shaft 514 is permitted to move linearly along the axis X relative to the block 508 and housing 502. The housing 502 is attached to one of the bracket assembly 20 and lower bracket 18. The shaft 514 is connected to the other of the bracket assembly 20 and the lower bracket 18. Preferably, the device 500 is mounted at the pivot point 32 of the seat 10 as illustrated in FIG. 3 about the axis X of FIG. 15.

The device 500 further includes a position member, indicated generally at 520. The position member 520 selectively moves the block 508 relative to the shaft 514 to either alter the engagement length of the splines or completely disengage the splines 512 and 518 from one another. The position member 520 includes a threaded shaft 522 which engages with a threaded bore 524 formed in a member 526 fastened to the cover 504. An engagement member 528 is mounted on an end of the shaft 522 and contacts the block 508. Preferably, the position member 520 is not connected directly with the block 508, but rather is engaged therewith by the abutment of the engagement member 528 to an end surface 530 of the block 508. Preferably, the engagement member 528 is rotatably mounted on the end of the shaft 522. The block 508 is biased against the engagement member 528 by a spring 532.

The device 500 further includes a controller, such as a motor 534. The motor 534 is coupled to the shaft 522 to provide rotationally movement thereof. The threaded connection of the shaft 522 to the cover 504 enables the rotary motion of the shaft 522 to be converted to linear motion of the block 508 via the position member 520. Preferably, the motor 534 is a fast acting high speed electrical motor for rapidly moving the block 508. However, it should be understood that any suitable mechanism can be substituted for the motor 534 and position member 520 which can move the block 508 into a desired position relative to the shaft 514.

To adjust the rotational position of the seat back 14 relative to the seat bottom 16 such as for the reclining function, the motor 534 is activated to rotate the shaft 522 in the appropriate direction causing the shaft 522 and the engagement member 528 to move rightward, as viewing FIG. 15. The spring 532 urges the block 508 also move in the rightward direction. Sufficient movement of the block causes the disengagement of the splines 512 and 518. The shaft 514 is then allowed to rotate relative to the housing 502. Since the seat back 14 is connected to one of the shaft 514 or housing 502, the seat back 14 can be rotated to a desired rotational position. To maintain the desired rotational position of the seat back 14, the motor is actuated in the opposite direction to re-engage the splines 512 and 518. Engagement of the splines generally prevents rotational movement of the seat back 14 during normal operation of the seat, e.g., below a threshold value representative of an impact situation.

During an impact situation, a sufficient force acting on the shaft 514 will cause deformation of one or both of the engaged splines 512 and 518. The shaft 514 and the block 508 are preferably made of materials, such as metal, which are selected to perform sufficient deformation with a given force input. The number, size, and composition of the splines 512 and 518 can be changed to alter the deformation characteristics, and therefore the amount and rate of energy absorption.

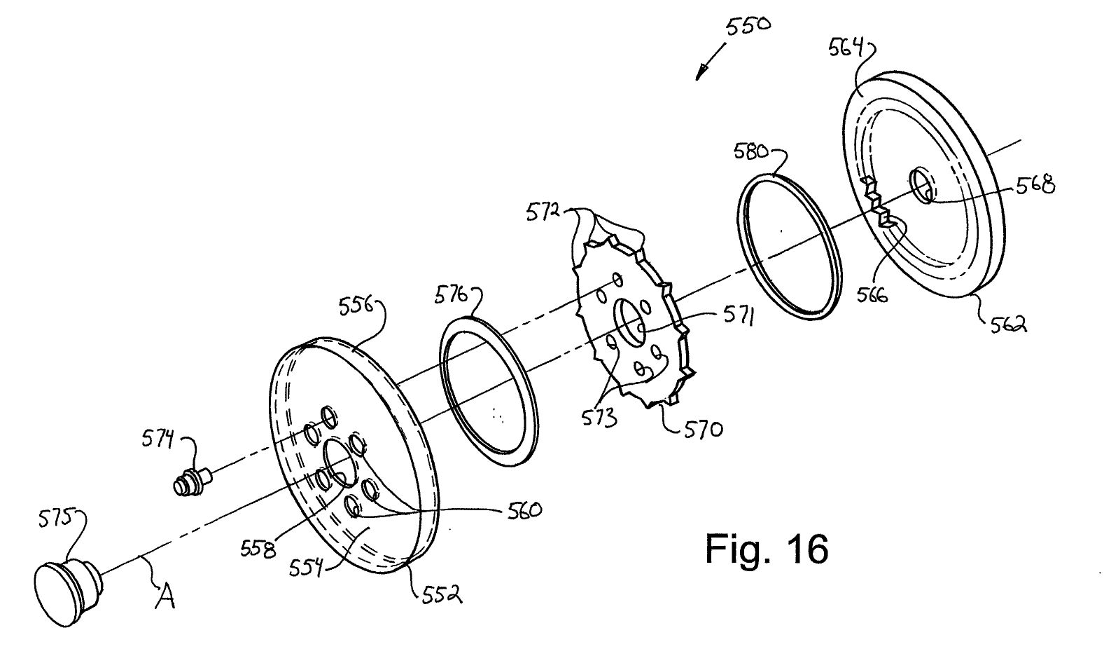

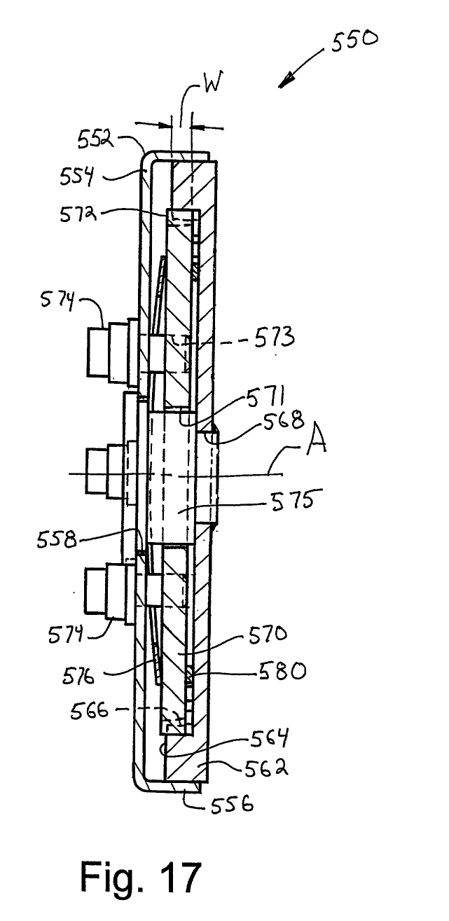

The device 500 can be actively controlled to effect the acceleration of the seat back 14 relative to time by actuation of the motor 534. The motor 534 can be actuated by a control unit (not shown) in communication with various sensors, as described above, to position the block 508 relative to the shaft 514 to alter the engagement length of the splines 512 and 518. The engagement length of the splines 512 and 518 corresponds to the amount of material which is deformed under the relatively high rotational loads. Thus, the device can be actively controlled so that the energy dissipating rates relative to time can be altered depending on the severity of the impact force. There is illustrated in FIGS. 16 and 17 another embodiment of an energy management device, indicated generally at 550. The device 550 is similar in structure and function to the device 500 in that the device 550 uses deformation of a relative solid yet deformable material to control the motion of two components, such as the seat back 14 relative to the seat bottom 16. The device 550 is relatively flat and can be advantageously included into a seat recliner mechanism with limited packaging space.

The device 550 includes a cover 552 having a generally flat circular disk portion 554 and an annular ridge 556 extending outwardly from the circumference of the disk portion 554. The disk portion 554 includes a central hole 558 and a plurality of mounting holes 560 formed generally around the central hole 558. The cover 552 is attached to an outer member 562 and is fixed relative thereto, such as by a weld or other suitable fastener. The outer member 562 includes an annular ridge 564 formed therein including a plurality of radially inwardly extending teeth 566 formed therein. The outer member 562 further includes a hole 568 formed therein.

A generally flat circular inner member 570 is disposed between the disk portion 554 and the outer member 562. The inner member 570 has a central hole 571 formed therethrough. The inner member 570 also has a plurality of mounting holes 573 formed therein corresponding to the mounting holes 560 formed in the disk portion 554. The inner member 570 includes a plurality of teeth 572 extending radially outwardly from the circumference of the inner member 570. The teeth 572 engage with the teeth 566 formed in the outer member 562. The inner member 570 is preferably rotationally fixed relative to the cover 552 about an axis A by a plurality of pins 574, but the inner member 570 is permitted to move axially about the axis A.

A pivot shaft 575 is disposed in the hole 568 and is fixedly mounted on the outer member 562, such as by a weld. Thus, the pivot shaft 575 and the outer member 562 are coupled for rotation about the axis A. Preferably, the hole 558 formed in the cover 552 and the hole 571 formed inner member 570 have a larger diameter than the corresponding portions of the pivot shaft 575 to provide clearance therebetween. The pivot shaft 575 can be connected with one of the bracket assembly 20 and the lower bracket 18, as discussed above relative to the device 12, for example. The cover 552 can be connected with the other of the bracket assembly 20 and the lower bracket 18.

The device 550 further includes a spring element 576 disposed between the disk portion 554 and the inner member 570. The spring element 576 biases the inner member 570 towards the outer member 562 for a greater engagement length for the width W of the mating teeth 566 and 572. The spring element 576 can be any suitable spring mechanism, such as a Belleville washer or wave spring.

The device 550 further includes a relatively thin ring shaped actuator 580 disposed between the inner member 570 and the outer member 562. The actuator 580 performs a similar function as the motor 534 of the device 500 in that the actuator positions the inner member 570 relative to the outer member 562 to alter the engagement width W of the teeth 566 and 572. The actuator 580 can be any suitable mechanism for providing this function. For example, the actuator 580 can be made of a shape memory alloy or wire, such as nickel-titanium or nitinol, which changes shape when heated and cooled, for example by an electric current running through the wire. Other examples of actuators include piezo-electric, solenoid, or an electric motor with drive screw.

During an impact situation, a sufficient force acting of the pivot shaft 575 will cause rotation of the outer member 562 relative to the inner member 570, thereby causing deformation of one or both of the engaged teeth 566 and 572. The inner member 570 and the outer member 562 are preferably made of materials, such as metal, which are selected to perform sufficient deformation with a given force input. The number, size, and composition of the teeth 566 and 572 can be changed to alter the deformation characteristics, and therefore the amount and rate of energy absorption. The device 550 can be actively controlled to effect the acceleration rate of the seat back 14 relative to time by actuation of the actuator 580. The actuator 580 can be actuated and controlled by a control unit (not shown) in communication with various sensors, as described above, to position the inner member 570 relative to the outer member 562 to alter the engagement width W of the teeth 566 and 572. The engagement width W corresponds to the amount of material which is deformed under the relatively high rotational loads. Thus, the device can be actively controlled so that the energy dissipating rates relative to time can be altered depending on the severity of the impact force.

It should be understood that the device 550 can have any suitable configuration which permits the inner member 570 to move relative to the outer member 562. For example, the input shaft 575 could be fastened to the outer member 562 to permit rotation therebetween while restricting translation along the axis A. The inner member 570 could be threadably engaged with the pivot shaft 575 along the hole 571 having mating threads formed therebetween. When the pivot shaft 575 is rotated about its axis A, the inner member 570 is rotated, thereby charging its engagement with the outer member 562.

Pyrotechnics may also be used to position the inner member 570 relative to the outer member 562. Pyrotechnics may further be used with metal deformation energy management devices, such as the devices 500 and 550, to remove specific numbers and locations of mating structures, such as splines and teeth giving adaptively of the device without changing the engagement length of the mating structures. Instead, the pyrotechnics will reduce the number of mating structures to a desired amount, thereby effecting the amount of mating material.

It should be understood that other types of material working of deformation can be used for the energy management devices of the present invention. Other examples include, extrusion, shearing, and compression. The amount of deformation can be controlled by varying the amount of material being deformed.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. An apparatus for a vehicle comprising:
a vehicle component including:
a first portion; and
a second portion movable relative to the first portion; and
an energy management device connected to said first and second portions, said device controlling the motion of said second portion relative to said first portion through a duration of time during rapid acceleration of the vehicle component to reduce peak acceleration forces acting on the vehicle component.

2. The apparatus of claim 1, wherein said device is controlled such that the motion of said second portion relative to said first portion is altered depending on the severity of impact forces acting on said vehicle component.

3. The apparatus of claim 1, wherein said device is controlled by an electronic control unit.

4. The apparatus of claim 2, wherein said device is controlled such that the motion of said second portion relative to said first portion is altered based upon information from a sensor detecting the speed of the vehicle.

5. The apparatus of claim 2, wherein said vehicle component is a vehicle seat, and wherein said first portion is a seat bottom, and said second portion is a seat back pivotally connected to said seat bottom, and wherein said device is controlled such that the motion of said seat back relative to said seat bottom is altered based upon information from a sensor detecting the weight of an occupant of said seat.

6. The apparatus of claim 2, wherein said vehicle component is a vehicle seat, and wherein said first portion is a seat bottom, and said second portion is a seat back pivotally connected to said seat bottom, and wherein said device is controlled such that the motion of said seat back relative to said seat bottom is altered based upon information from a sensor detecting the position of the seat relative to the floor of the vehicle.

7. The apparatus of claim 2, wherein said vehicle component is a vehicle seat, and wherein said first portion is a seat bottom, and said second portion is a seat back pivotally connected to said seat bottom, and wherein said device is controlled such that the motion of said seat back relative to said seat bottom is altered based upon information from a sensor detecting the position of the seat back relative to said seat bottom.

8. The apparatus of claim 2, wherein said device is controlled such that the motion of said second portion relative to said first portion is altered based upon information from a proximity sensor detecting an imminent impact.

9. The apparatus of claim 2, wherein said device is controlled such that the motion of said second portion relative to said first portion is altered based upon information from a sensor detecting acceleration of the vehicle.

10. The apparatus of claim 2, wherein said device controls the motion of said second portion relative to said first portion in real time based on a force input acting on said device.

11. The apparatus of claim 1, wherein said vehicle component is adapted to contact an occupant of the vehicle such that said device reduces peak acceleration forces experienced by the occupant.

12. The apparatus of claim 1, wherein said vehicle component is a vehicle seat, and wherein said first portion is a seat bottom, and said second portion is a seat back pivotally connected to said seat bottom.

13. The apparatus of claim 12, further including a recliner mechanism for adjustably mounting said seat back to said seat bottom, wherein the recliner mechanism can be actuated to adjust the angle of said seat back relative to said seat bottom.

14. The apparatus of claim 13, further including an unlatching mechanism to selectively disengage said recliner mechanism to said seat back.

15. The apparatus of claim 13, wherein said recliner mechanism will maintain said seat back at a desired angle relative to said seat bottom when an input force acting upon said seat back is below a predetermined value.

16. The apparatus of claim 12 further including a restraint belt having ends fastened to said seat for restraining an occupant onto said seat.

17. The apparatus of claim 12, wherein said device controls the rotational motion of said seat back relative to said seat bottom within a range of about 20 to about 30 degrees.

18. The apparatus of claim 1, wherein said vehicle component is a seat track assembly, wherein said first portion is a lower track and said second portion is an upper track slidably mounted relative to said lower track.

19. The apparatus of claim 1, wherein the motion of the second portion relative to said first portion is linear.

20. The apparatus of claim 1, wherein the motion of the second portion relative to said first portion is rotational.

21. The apparatus of claim 1, wherein said device comprises:
a cylinder including:
a housing having a bore formed therein, said housing operatively connected to said first portion; and
a piston slidably disposed in said bore of said housing such that said piston and said bore define first and second chambers, said piston operatively connected to said second portion; and
a valve for regulating the flow of fluid between said first and second chambers.

22. The apparatus of claim 21, wherein said device is self-adaptive in that said device controls the motion of said second portion relative to said first portion based on a force input acting on one of said piston and housing.

23. The apparatus of claim 21, wherein said device is self-adaptive in that said device controls the motion of said second portion relative to said first portion based on a pressure input acting on one of said first and second chambers.

24. The apparatus of claim 21, wherein said device is self-adaptive in that said device controls the motion of said second portion relative to said first portion based on the velocity of said piston relative to said housing.

25. The apparatus of claim 21, wherein said device is self-adaptive in that said device controls the motion of said second portion relative to said first portion based on the displacement of said piston relative to said housing.

26. The apparatus of claim 25, wherein said housing includes a plurality of passageways formed therein along the length of said bore, said passageways being selectively in fluid communication with said first and second chambers and are closed off from communication between said first and second chambers depending on the position of said piston relative to said housing.

27. The apparatus of claim 25, wherein said valve is defined by a longitudinal groove formed in an inner surface defining said bore, said groove having a stepped configuration such that portions along the length of said groove have varying depths, said first and second chambers being in fluid communication via said groove, and wherein the position of said piston along the length of said groove effects the cross-sectional area of the groove.

28. The apparatus of claim 21, further including a pressure relief valve in fluid communication with said first and second chambers, said pressure relief valve being in series with said valve, said pressure relief valve movable to an open position upon a threshold pressure within one of said first and second chambers to permit the flow of fluid between one of said first and second chambers and said valve.

29. The apparatus of claim 1 wherein said valve includes a restrictive orifice disposed in the flow path between said first and second chambers causing said piston to move in a resistive manner relative to the velocity of the translation of said piston.

30. The apparatus of claim 29, wherein said valve regulates the flow of fluid between said first and second chambers by altering the effective cross-sectional area of said orifice.

31. The apparatus of claim 21, wherein said valve is controllable by a solenoid.

32. The apparatus of claim 21 further including a control valve for altering the position of said first portion relative to said second portion, wherein said control valve is movable between an open position in which fluid is permitted to flow between said first and second chambers, and a closed position in which fluid is prevented from flowing between said first and second chambers.

33. The apparatus of claim 32, wherein said control valve is a ball valve.

34. The apparatus of claim 32, wherein said vehicle component is a vehicle seat, and wherein said first portion is a seat bottom, and said second portion is a seat back pivotally connected to said seat bottom.

35. The apparatus of claim 21 including:
a second housing having a bore formed therein;
a second valve slidably disposed in said bore of a second housing, said second valve being biased by pressure forces from said first and second chambers acting on opposing faces of said second valve, wherein the position of said second valve in said bore of said second housing effects the flow of fluid between said first and second chambers.

36. The apparatus of claim 21, wherein the fluid within said first and second chambers is a magneto-rheological fluid, and wherein said valve regulates the flow of fluid between said first and second chambers by exposing said fluid to a magnetic field to alter the effective viscosity of the fluid.

37. The apparatus of claim 21, wherein the fluid within said first and second chambers is an electro-rheological fluid, and wherein said valve regulates the flow of fluid between said first and second chambers by exposing said fluid to an electrical field to alter the effective viscosity of the fluid.

38. The apparatus of claim 1, wherein said device comprises:
a rotary damper including:
a housing having an arcuate cavity formed therein, said housing operatively connected to said first portion; and
a vane pivotally disposed in said cavity such that said vane and said cavity define first and second chambers, said vane operatively connected to said second portion; and
a valve for regulating the flow of fluid between said first and second chambers.

39. The apparatus of claim 1, wherein said device comprises:
a cylinder including:
a housing having a bore formed therein;
a member movable relative to said housing, said member operatively connected to said first portion;
a spring connected between said housing and said member; and
a piston slidably disposed in said bore of said housing such that said piston and said bore define first and second chambers, said piston operatively connected to said second portion; and
a valve for regulating the flow of fluid between said first and second chambers, wherein said valve is controlled by the position of said member relative to said housing, said member being movable relative to said housing against the bias of said spring by an input force acting on said member.

40. The apparatus of claim 1, wherein said device includes first and second members engaged with one another, said first member being operatively connected to said first portion, said second member being operatively connected to said second portion, at least one of said members being deformable relative to the other of said members when acted upon by a predetermined force, and wherein said device controls the motion of said second portion relative to said first portion by altering the amount of deformation of said at least one of said members.

41. The apparatus of claim 40, wherein said first and second members are movable in engagement with one another by a controller which controls the amount of deformable material between said first and second members.

42. The apparatus of claim 41, wherein said controller is a motor.

43. The apparatus of claim 41 wherein said controller can be made of a shape memory alloy which changes shape upon temperature change.

44. The apparatus of claim 40, wherein said first and second members are engaged with one another by mating splines.

45. The apparatus of claim 40, wherein said first and second members are engaged with one another by mating teeth.

46. An energy management device for controlling the motion between first and second components of a vehicle comprising:
a cylinder including:
a housing having a bore formed therein, said housing operatively connected to the first portion; and
a piston slidably disposed in said bore of said housing such that said piston and said bore define first and second chambers, said piston operatively connected to the second portion; and
a valve for regulating the flow of fluid between said first and second chambers, wherein the fluid within said first and second chambers is one of a magneto-rheological and electro-rheological fluid, and wherein said valve regulates the flow of fluid between said first and second chambers by exposing said fluid to one of a magnetic field and electrical field, respectively, to alter the effective viscosity of the fluid.

47. An energy management device for controlling the motion between first and second components of a vehicle comprising:
a cylinder including:
a housing having a bore formed therein, said housing operatively connected to the first portion; and
a piston slidably disposed in said bore of said housing such that said piston and said bore define first and second chambers, said piston operatively connected to the second portion; and
a valve for regulating the flow of fluid between said first and second chambers, wherein said valve is defined by a longitudinal groove formed in an inner surface defining said bore, said groove having a stepped configuration such that portions along the length of said groove have varying depths, said first and second chambers being in fluid communication via said groove, and wherein the position of said piston along the length of said groove effects the cross-sectional area of the groove.

48. An energy management device for controlling the motion between first and second components of a vehicle comprising:
a cylinder including:
a housing having a bore formed therein, said housing operatively connected to the first portion; and
a piston slidably disposed in said bore of said housing such that said piston and said bore define first and second chambers, said piston operatively connected to the second portion; and
a valve for regulating the flow of fluid between said first and second chambers, wherein said valve includes a restrictive orifice disposed in the flow path between said first and second chambers causing said piston to move in a resistive manner relative to the velocity of the translation of said piston, and wherein said valve includes a mechanism for altering the cross-sectional area of said orifice.

49. A method of controlling the motion of first and second portions of a vehicle component comprising:
a. providing a vehicle component including a first portion movable relative to a second portion;
b. controlling the motion of the second portion relative to the first portion through a duration of time during rapid acceleration of the vehicle component to reduce peak acceleration forces acting on the vehicle component.

50. The method of claim 49, wherein the motion of the second portion relative to the first portion is altered depending on the severity of impact forces acting on the vehicle component.

51. The method of claim 49, wherein the motion of the second portion relative to the first portion is altered based upon factors selected from the group consisting of the speed of the vehicle, the weight of an occupant of a seat in which the vehicle component is installed, the position of the vehicle component relative to a fixed portion of the vehicle, detection of an imminent impact, the acceleration of the vehicle, and a force input acting on the vehicle component.
